(19) United States
(12) Patent Application Publication
(10) Pub. No.: US 2021/0146170 A1
(43) Pub. Date: May 20, 2021

(54) MASK

(71) Applicant: YUNG SHUN CHIU, Kaohsiung (TW)

(72) Inventor: YUNG SHUN CHIU, Kaohsiung (TW)

(21) Appl. No.: 17/095,714

(22) Filed: Nov. 11, 2020

(30) Foreign Application Priority Data
Nov. 18, 2019 (TW) 108215238

(51) Int. Cl. A62B 18/02; A62B 18/08; A41D 13/11

(52) U.S. Cl. CPC A62B 18/025; A41D 13/1115; A41D 13/1161; A62B 18/084

(57) ABSTRACT

A mask includes a web and an elastic supporting element. The web includes two portions corresponding to two cheeks of a user in use. The elastic supporting element is connected to the web to keep the portions of the web in the vicinity, yet allowing the portions of the web to be pivoted away from each other.

### BACKGROUND OF INVENTION

### 1. Field of Invention

The present invention relates to a mask and, more particularly, to a comfortable mask.

### 2. Related Prior Art

Referring to FIG. 1, a conventional mask 1 includes a web 10 and two elastic laces 11. Two ends of ach of the elastic laces 11 are tied to a corresponding lateral edge of the web 10. In use, a user puts the web 10 on his or her face and put the elastic laces 11 on his or her ears. The elastic laces 11 are expected to bring the web 10 close to the user's face to provide a good effect of protection. However, the user might feel uncomfortable in his or her face or ears if the elastic laces 11 are excessively tight.

The present invention is therefore intended to obviate or at least alleviate the problems encountered in the prior art.

### SUMMARY OF INVENTION

It is the objective of the present invention to provide an effective and comfortable mask.

To achieve the foregoing objective, the mask includes a web and an elastic supporting element. The web includes two portions corresponding to two cheeks of a user in use. The elastic supporting element is connected to the web to keep the portions of the web in the vicinity, yet allowing the portions of the web to be pivoted away from each other.

In another aspect, the web is divided into the portions along a midline.

In another aspect, the web includes two lateral edges, and each of the portions of the web is formed between the midline and a corresponding one of the lateral edges.

In another aspect, the lateral edges of the web are movable toward and from each other about the midline.

In another aspect, the elastic supporting element is made of an electrically insulating material.

In an alternative aspect, the elastic supporting element is made of metal.

In another aspect, the elastic supporting element is made of a shape memory alloy.

In another aspect, the elastic supporting element is an elongated element.

In another aspect, elastic supporting element includes two lateral sections and an upper section formed between the lateral sections. The web includes two lateral edges and an upper edge formed between the lateral edges, wherein the upper section of the elastic supporting element extends in the vicinity of the upper edge of the web in parallel to each other. Each of the lateral sections of the elastic supporting element extends in the vicinity of a corresponding one of the lateral edges of the web in parallel to each other.

In another aspect, the elastic supporting element includes a lower section formed between the lateral sections. The web includes a lower edge formed between the lateral edges. The lower section of the elastic supporting element extends in the vicinity of the lower edge of the web in parallel to each other.

In another aspect, the upper section of the elastic supporting element is connected to the lateral sections.

In an alternative aspect, the upper section of the elastic supporting element is separated from the lateral sections.

In another aspect, the elastic supporting element is evenly located in the web.

In another aspect, the web includes pleats.

Other objectives, advantages and features of the present invention will be apparent from the following description referring to the attached drawings.

### BRIEF DESCRIPTION OF DRAWINGS

The present invention will be described via detailed illustration of six embodiments versus the prior art referring to the drawings wherein:

FIG. 1 is a perspective view of a conventional mask;

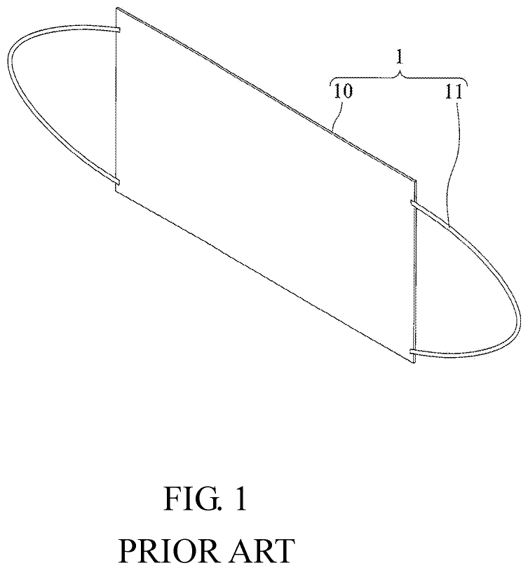

FIG. 2 is a perspective view of a mask according to the first embodiment of the present invention;

FIG. 3 is a front view of the mask shown in FIG. 2;

FIG. 4 is a perspective view of an elastic supporting element used in or on the mask shown in FIG. 2;

FIG. 5 is another perspective view of the mask shown in FIG. 2;

FIG. 6 is a perspective view of the mask in another position than shown in FIG. 5;

FIG. 7 is a side view of a user wearing the mask shown in FIG. 2;

FIG. 8 is a perspective view of a mask according to the second embodiment of the present invention;

FIG. 9 is a front view of a mask according to the third embodiment of the present invention;

FIG. 10 is a perspective view of a mask according to the fourth embodiment of the present invention;

FIG. 11 is a perspective view of a mask according to fifth embodiment of the present invention; and

FIG. 12 is a perspective view of a mask according to the sixth embodiment of the present invention.

### DETAILED DESCRIPTION OF EMBODIMENTS

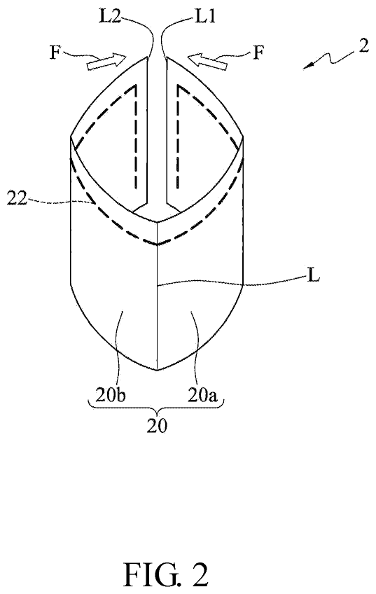

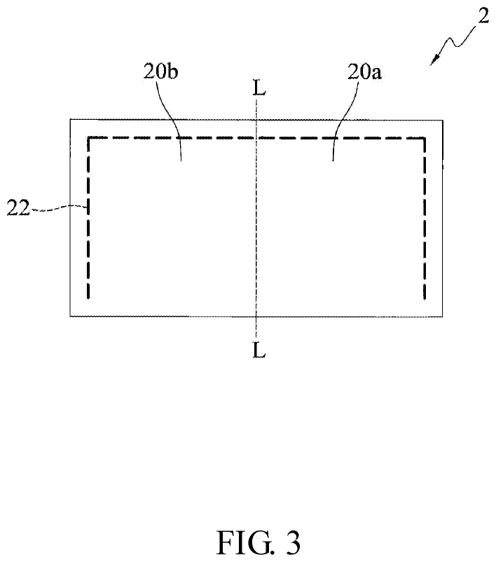

Referring to FIGS. 2 and 3, a mask 2 includes a web 20 and an elastic supporting element 22 according to a first embodiment of the present invention. The web 20 is a flexible laminate that includes several layers of various materials. The web 20 includes two portions or halves 20a and 20b, a midline L, two lateral edges L1 and L2, an upper edge (not numbered) and a lower edge (not numbered). The portion 20a is located between the midline L and the lateral edge L1. The portion 20b is located between the midline L and the lateral edge L2. The area of the portion 20a is identical to the area of the portion 20b.

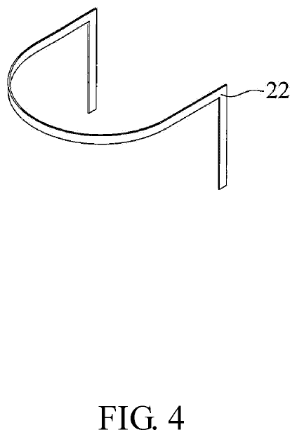

Referring to FIG. 4, the elastic supporting element 22 includes an upper section (not numbered) formed between two lateral sections (not numbered). The elastic supporting element 22 is connected to the web 20. The elastic supporting element 22 is located in or on the web 20. The upper section of the elastic supporting element 22 extends in the vicinity of the upper edge of the web 20, substantially parallel to each other. Each of the lateral sections of the elastic supporting element 22 extends in the vicinity of the lateral edge L1 or L2, substantially parallel to each other.

The elastic supporting element 22 is like a clip. Normally, the elastic supporting element 22 shrinks to bring the lateral sections thereof close to each other as indicated with two arrow heads F referring to FIG. 2. The lateral sections of the elastic supporting element 22 can be located far from each other as shown in FIG. 3.

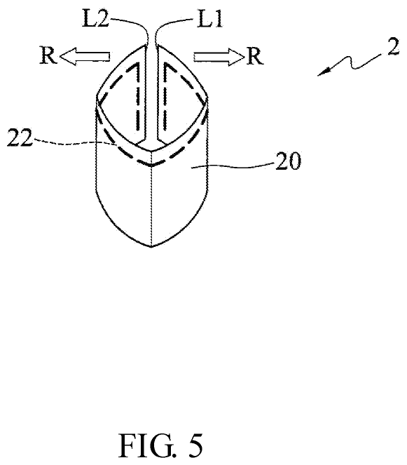

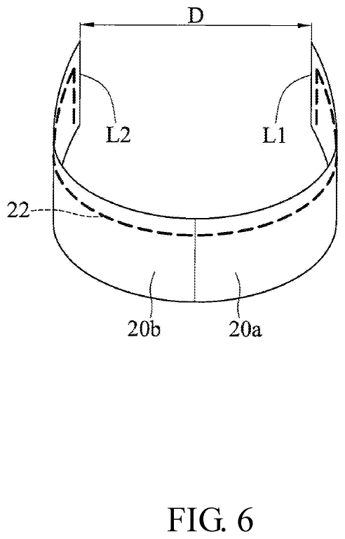

The mask 2 is moveable to a position shown in FIG. 6 from a position shown in FIG. 5 as indicated with two arrow heads R before it is put on the face of a user.

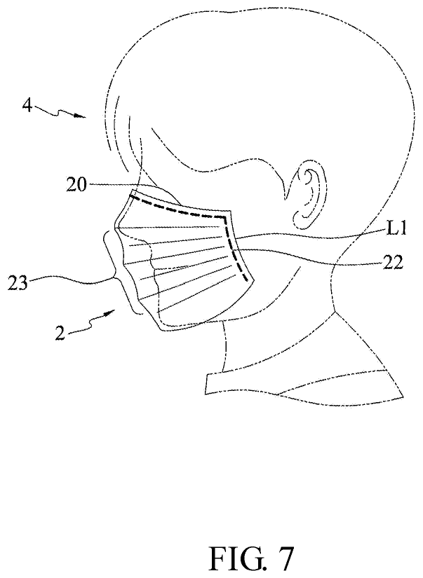

Referring to FIG. 7, the mask 2 is put on the face of the user. Then, the mask 2 is released to allow the elastic supporting element 22 to keep the web 20 close to the face of the user.

The elastic supporting element 22 is made of an electrically insulating material or metal. Preferably, the elastic supporting element 22 is made of metal such as gold (Au), cadmium (Cd), silver (Ag), copper (Cu), zinc (Zn), aluminum (Al), tin (Sn), silicon (Si), gallium (Ga), indium (In), titanium (Ti), nickel (Ni), iron (Fe), platinum (Pt), lead (Pb), niobium (Nb), uranium (U) and manganese (Mn).

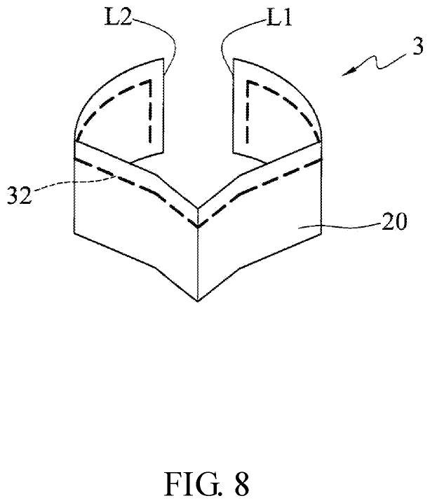

Referring to FIG. 8, there is shown a mask 3 according to a second embodiment of the present invention. The mask 3 is identical to the mask 2 except for including an elastic supporting element 32 instead of the elastic supporting element 22. The elastic supporting element 32 is identical to the elastic supporting element 22 except for being made of a shape memory alloy such as a gold-cadmium alloy, a silver-cadmium alloy, a copper-zinc alloy, a copper-zinc-aluminum alloy, a copper-zinc-tin alloy, a copper-zinc-silicon alloy, a copper-tin alloy, a copper-zinc-gallium alloy, an indium-titanium alloy, a gold-copper-zinc alloy, a nickel-aluminum alloy, an iron-platinum alloy, a titanium-nickel alloy, a titanium-nickel-lead alloy, a titanium-niobium alloy, a uranium-niobium alloy and an iron-manganese-silicon alloy. For the use of the shape memory alloy in the elastic supporting element 22, the mask 2 of the second embodiment can be more compliant to the face of the user than the mask 2 of the first embodiment.

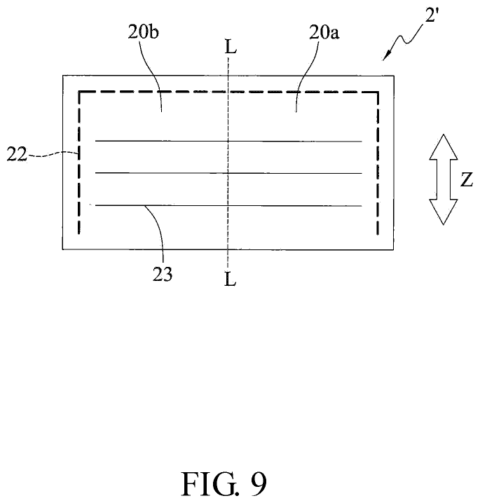

Referring to FIG. 9, there is shown a mask 2′ according to a third embodiment of the present invention. The mask 2′ is identical to the mask 2 except for that the web 20 includes pleats 23.

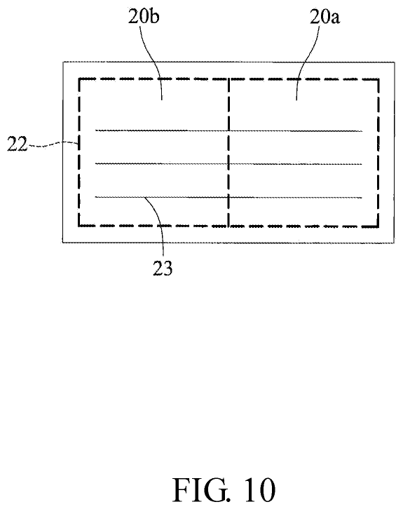

Referring to FIG. 10, there is shown a mask according to a fourth embodiment of the present invention. The fourth embodiment is identical to the third embodiment except for that the elastic supporting element 22 extends in a rectangular manner. That is, the elastic supporting element 22 includes a lower section in addition to the upper section and the lateral sections.

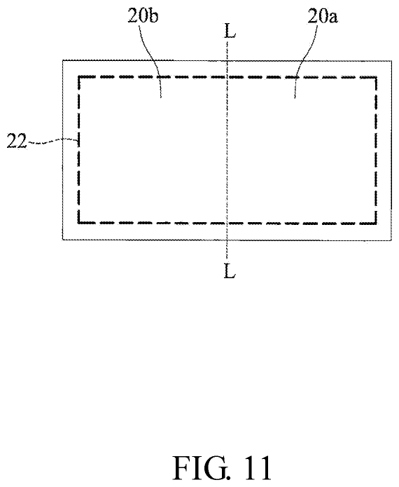

Referring to FIG. 11, there is shown a mask according to a fifth embodiment of the present invention. The fifth embodiment is identical to the fourth except for omitting the pleats 23.

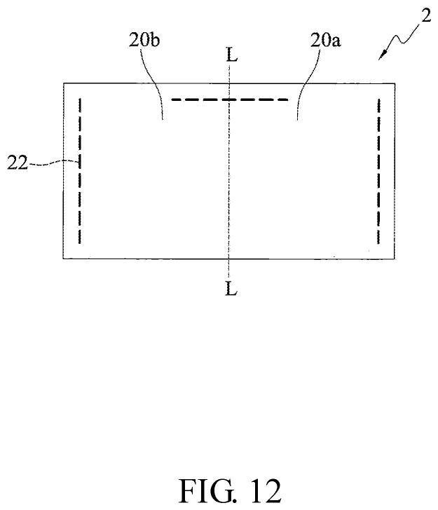

Referring to FIG. 12, there is shown a mask according to a sixth embodiment of the present invention. The sixth embodiment is identical to the first embodiment except for that the upper section of the elastic supporting element 22 is separated from the lateral sections of the elastic element 22. That is, the mask 2 of the sixth embodiment actually includes an upper elastic supporting element 22 and two lateral elastic supporting elements 22.

As discussed above, in the use of the mask 2 or 3, the elastic supporting element 22 keeps the web 20 in contact with the face of the user. However, the mask 2 or 3 cannot and will not cause the user feel uncomfortable in his or her ears.

The present invention has been described via the illustration of the embodiments. Those skilled in the art can derive variations from the embodiments without departing from the scope of the present invention. Hence, the embodiments shall not limit the scope of the present invention defined in the claims.

1. A mask comprising:
a web comprising two portions corresponding to two cheeks of a user in use; and
an elastic supporting element connected to the web to keep the portions of the web in the vicinity, yet allowing the portions of the web to be pivoted away from each other.

2. The mask according to claim 1, wherein the web is divided into the portions along a midline.

3. The mask according to claim 2, wherein the web comprises two lateral edges, wherein each of the portions of the web is formed between the midline and a corresponding one of the lateral edges.

4. The mask according to claim 2, wherein the lateral edges of the web are movable toward and from each other about the midline.

5. The mask according to claim 1, wherein the elastic supporting element is made of an electrically insulating material.

6. The mask according to claim 1, wherein the elastic supporting element is made of metal.

7. The mask according to claim 6, wherein the elastic supporting element is made of a shape memory alloy.

8. The mask according to claim 1, wherein the elastic supporting element is an elongated element.

9. The mask according to claim 8, wherein the elastic supporting element comprises two lateral sections and an upper section formed between the lateral sections, wherein the web comprises two lateral edges and an upper edge formed between the lateral edges, wherein the upper section of the elastic supporting element extends in the vicinity of the upper edge of the web in parallel to each other, wherein each of the lateral sections of the elastic supporting element extends in the vicinity of a corresponding one of the lateral edges of the web in parallel to each other.

10. The mask according to claim 9, wherein the elastic supporting element comprises a lower section formed between the lateral sections, wherein the web comprises a lower edge formed between the lateral edges, wherein the lower section of the elastic supporting element extends in the vicinity of the lower edge of the web in parallel to each other.

11. The mask according to claim 9, wherein the upper section of the elastic supporting element is connected to the lateral sections.

12. The mask according to claim 9, wherein the upper section of the elastic supporting element is separated from the lateral sections.

13. The mask according to claim 1, wherein the elastic supporting element comprises two lateral portions connected to the portions of the web, respectively.

14. The mask according to claim 1, wherein the elastic supporting element is located in the web.

15. The mask according to claim 14, wherein the elastic supporting element is evenly located in the web.

16. The mask according to claim 1, wherein the web comprises pleats.
